(19) United States
(12) Patent Application Publication
(10) Pub. No.: US 2025/0315793 A1
(43) Pub. Date: Oct. 9, 2025

(54) SYSTEM AND METHOD FOR CONNECTING ATHLETES AND COACHES FOR RECRUITING AND ENDORSEMENT

(71) Applicants: Wesley Fluellen, Cleveland, OH (US); Joshua E. Akognon, Overland Park, KS (US)

(72) Inventors: Wesley Fluellen, Cleveland, OH (US); Joshua E. Akognon, Overland Park, KS (US)

(21) Appl. No.: 18/626,463

(22) Filed: Apr. 4, 2024

(51) Int. Cl. G06Q 10/1053; H04N 7/14

(52) U.S. Cl. CPC G06Q 10/1053; H04N 7/141

(57) ABSTRACT

A system revolutionizes the recruitment and endorsement processes for athletes. The system comprises user devices, a communication network (108), and a server (114) configured to facilitate the registration of users (102) as athletes or recruiters. A memory component segregates and stores user data based on registration type, while a processor executes various modules. An event tracker module generates invitations for events, enrolls users responding to invitations, and creates event-specific groups. A virtual video interaction module enables the connection of enrolled users with event recruiters, allowing for virtual interactions and final evaluations. A matching module, utilizing stored data and recruiter evaluations, shortlists users from the group. A negotiation mechanism within the platform relies on the active involvement of athletes and coaches, underscoring the indispensable role of human input in shaping the outcome of agreements. The system enhances athlete visibility, streamlines recruitment procedures, and establishes meaningful connections between athletes and recruiters.

### BACKGROUND OF THE INVENTION

### 1. Field of the Invention

The present invention relates to the field of sports management and, more particularly, to a system and a method for facilitating connections between athletes or coaches and sports recruiters to provide a comprehensive athlete evaluation for recruiting and endorsement of the athletes/coaches for various sporting events.

### 2. Description of the Prior Art

Recent estimations indicate that approximately 500,000 collegiate athletes are currently playing sports at the various levels of collegiate competition. Most of these athletes, around 420,000 in total, are in the NCAA, including Divisions I, II, and III. Additionally, there are roughly 60,000 athletes in the NAIA and about 20,000 in the NJCAA or JUCO. This has resulted in over 100,000 student-athletes being recruited annually across different collegiate competition levels.

Most schools allocate budgets for coaches to recruit talented student-athletes; a significant amount of resources and manpower for extensive scouting is required for a comprehensive evaluation of athletes during the selection process. This hampers the discovery of potential collegiate-level players, leaving many students unaware of such opportunities. Furthermore, the limitations, especially in budget and personnel, create a disparity, with larger schools having a significant advantage over the smaller or lower-level schools.

Athletes often seek help from recruiting companies that claim to have connections with college coaches. Such recruiting companies charge an exorbitant fee to assist in connecting with a suitable university and securing a scholarship. Athletes usually hand over their athletic performance video and pay the fee to the company that, at its discretion, provides athletic details to certain college coaches and athletic departments. Such a process has minimum involvement of the athlete who often time ends up getting a lesser endorsement deal than their actual worth. Another significant issue is presented when recruiting companies contact coaches excessively. This practice frequently leads coaches to dislike such recruiting companies and their tactics, thereby producing a negative impact on the athletes who pay fees to engage these companies.

Therefore, in the ever-evolving landscape of sports recruitment and athlete endorsement, the traditional methods of scouting and connecting athletes with coaches have faced challenges in terms of efficiency and accessibility. The conventional methods have often been characterized by inefficiencies, lack of transparency, and limited direct interactions between athletes and recruiters. With the rise of technology, there's a growing need for innovative solutions to streamline the recruiting process, enhance athlete visibility, and facilitate meaningful connections between athletes and relevant stakeholders such as coaches and endorsement entities. Accordingly, there exists a need for an efficient method and an accessible system to bridge this gap and ensure that talented athletes, regardless of school size, are not overlooked.

Thus, there is a need in the art to develop a comprehensive system and a method that facilitates the connection between athletes and college coaches for recruiting and endorsement purposes. Such a system would involve coaches from various educational and professional institutions who show an active interest in recruiting athletes for specific sports through a formalized verification process, thereby ensuring that only genuinely interested coaches are part of the system.

There is additionally a need for a system and a method for evaluating key athletic skills to identify top athletic performers, conducting classes and workshops for academics, athletics, and financial guidance, and offering a mechanism for players or athletes to negotiate better endorsement deals within the system.

### OBJECTIVE OF THE INVENTION

The principal objective of the present invention is to address the challenges encountered in the existing state of the art, particularly in the realm of athlete recruitment and endorsement.

The objective of the present invention is to develop a system and a method that seamlessly connects athletes and coaches. Coaches from colleges, universities, prep schools, and professional teams can actively engage in recruiting athletes for various sports, thus fostering efficient and effective recruiting processes.

Another objective of the present invention is to provide a standardized and comprehensive method for assessing athletic skills, including speed, power, strength, and agility.

Yet another objective of the present invention is to facilitate virtual video interactions between athletes and coaches. This would offer a dynamic environment for classes, seminars, workshops, and in-depth interviews to support the academic, athletic, and financial aspects of the athletes' pursuits.

A further objective of the present invention is to introduce a pay-by-player model, enabling coaches, organizations, and endorsement companies to purchase information on potential sports prospects individually, thereby enhancing flexibility and cost-effectiveness in the recruitment process.

### SUMMARY OF THE INVENTION

The present invention provides a system and a method incorporating user devices, a communication network, and a server for efficient data processing to facilitate athlete recruitment and endorsement by coaches/recruiters.

Generally stated, the system for facilitating recruitment and endorsement of athletes, comprises a server, wherein the server is adapted to receive and store user data from one or more user devices for registration of a plurality of users as athletes or recruiters to said system over a communication network that connects the one or more user devices to the system and registers the plurality of users as either athletes or coaches or recruiters; a database in communication with the server and configured to store segregated user data based on a user registration type, one or more event details, and one or more sets of predefined evaluation parameters; an event tracker module configured to generate and send invitations for an event initiated by at least one registered user to one or more registered user devices via the communication network based on a matching of upcoming event criteria pre-stored in the database and the user data, and receive responses from the one or more registered users and enroll the one or more registered users in the event; an account generation module configured to create at least one group of enrolled users for the event, wherein each account includes structured information deduced from the information received for registrations under a plurality of categories; a virtual video interaction module configured to generate and send a link to the enrolled users of said group to connect with said at least one registered user initiating the event for virtual video interaction and evaluation of the enrolled users online; and a matching module configured to shortlist candidates from the one or more enrolled users of said group by matching at least a set of one or more evaluation parameters for eligible candidates stored in the database with the structured information of an enrolled user for final evaluation.

In an embodiment, the system is configured to transmit real-time updates and notifications to the one or more enrolled users regarding the status of event invitations and user enrolments.

In an embodiment, the account generation module selects one or more of user preferences, historical participation, and performance data as part of the structured data.

In an embodiment, the virtual video interaction module facilitates video sessions, classes, seminars, in-depth interviews, and workshops for the enrolled users.

In an embodiment, the system comprises a communication module facilitating the reception and transmission of data to and from the system.

In another aspect, there is provide a method for facilitating recruitment and endorsement of athletes. Generally stated, the method comprises the steps of receiving and storing user data from one or more user devices for registration of a plurality of users as athletes or recruiters to said system over a communication network that connects the one or more user devices to the system and registers the plurality of users as either athletes or recruiters; storing segregated user data based on a user registration type, one or more event details, and one or more sets of predefined evaluation parameters in a database in communication with a server; generating and sending invitations for an event initiated by at least one registered user to one or more registered user devices via the communication network based on a matching of upcoming event criteria pre-stored in the database and the user data, and receiving responses from the one or more registered users and enrolling the one or more registered users in the event by an event tracker module; creating at least one group of enrolled users for the event using an account generation module, wherein each account includes structured information deduced from the information received for registrations under a plurality of categories; generating and sending a link to the enrolled users of said group to connect with said at least one registered user initiating the event for virtual video interaction and evaluation of the enrolled users online using a virtual video interaction module; and shortlisting candidates from the one or more enrolled users of said group by matching at least a set of one or more evaluation parameters for eligible candidates stored in the database with the structured information of an enrolled user for final evaluation by a matching module.

Various objects, features, aspects, and advantages of the inventive subject matter will become more apparent from the following detailed description of preferred embodiments, along with the accompanying drawing figures in which the same numerals represent like components.

### BRIEF DESCRIPTION OF THE DRAWINGS

FIG. 1 illustrates a system for connecting athletes and coaches/recruiters for the selection of athletes in accordance with an embodiment of the present invention;

FIG. 2 illustrates a method for the registration of athletes and coaches, for registering one or more users to the system, in accordance with an embodiment of the present invention; and

FIG. 3 illustrates a method for generating and managing an event, interaction, and recruitment of registered users, providing endorsement in accordance with an embodiment of the present invention.

FIG. 4 illustrates method 400 for the registration of an athlete on the platform in accordance with an embodiment of the present invention.

FIG. 5 illustrates method 500 for the registration of a coach on the platform in accordance with another embodiment of the present invention.

### DETAILED DESCRIPTION OF THE INVENTION

The embodiments herein and their various features and advantageous details are explained more fully with reference to the non-limiting embodiments illustrated in the accompanying drawings and the following description. Numerous variations, changes, and substitutions may occur to those skilled in the art without departing from the invention. It should be understood that various alternatives to the embodiments of the present disclosure herein may be employed.

For ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms used in the application, as all equivalents, synonyms, new developments, and terms or techniques that serve the same or a similar purpose are considered to be within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

The term “Sports Combines” refers to events where athletes' athletic skills, including speed, power, strength, and agility are tested. These events aim to identify top-performing players in each sport, making it easier for coaches, athletes, and recruiters to assess an athlete's overall athletic ability.

The term “Visual silhouette profiles” refers to a simplified, graphical representation of an athlete's physical form, often presented in a basic outline or shadow format. The use of visual silhouette profiles on the system allows coaches, organizations, and endorsement companies to conduct a preliminary assessment or search for potential sports prospects. This feature provides a quick visual overview of athletes, helping users gauge their physique, posture, and perhaps even the basic athletic stance. It serves as an initial screening tool before deciding to purchase complete information about a specific player from the system.

The term “Event recruiters”, such as scouts, coaches, or representatives from colleges and leagues, are connected to the event.

The term “Pay-by-player model”, enables coaches, organizations, and endorsement companies to purchase information on potential sports prospects individually. This ensures a flexible and cost-effective approach to accessing athlete profiles.

Systems, methods, devices, software, and computer-readable media, according to the present disclosure, are designed for communication and sharing information in various formats like text, audio, and video. The main focus is on helping people promote themselves to potential recruiters, including schools, universities, athletic leagues, teams, sponsors, and more. These tools can be employed for multiple purposes, such as creating and sharing instructional content for recruitment, identifying potential recruiters, preparing videos or other materials for recruiters, communicating with recruiters, and keeping track of communications and recruiter activities. Essentially, the system is versatile and can be adapted for a wide range of individuals and industries involved in recruitment and endorsement.

The disclosed system facilitates the recruitment and endorsement of athletes and/or coaches with events and professional teams. The system provides a choice for first-time users to identify themselves as an athlete or coach and register with the system for current or upcoming events, which facilitates tailored experiences based on their selection. Athletes and coaches are facilitated to create a profile for free on the platform and the system verifies and registers a user through different automized options.

The server is configured to receive the user data and verify whether the received data correctly identifies the chosen type of user. Upon such verification, the system registers the users as a chosen type, that is, athletes or coaches/recruiters, thereby allowing access to a pool of registered and verified athletes and/or coaches. For instance, an athlete creates a free profile and uploads a video of his performance in a game for evaluation. The system verifies the video for genuineness and upon approval sends further instructions to the athlete, including payment, for completion and registration of his profile. After the successful creation of said profile, athletes can browse through registered coaches and schools on the platform. In an alternate embodiment, the system may provide an option to visualize the playing arena listed in the system such as, but are not limited to, arial view of the basketball court of a registered school when packed with spectators, to get a better idea of the playing environment. Additionally, notifications may be sent to the registered athletes whenever new schools and/or new coaches register on the platform. Further, the athletes are also notified whenever a registered coach purchases their complete information from the platform.

In an alternate embodiment, the athletes are provided the option to purchase services from the platform. Such services include but are not limited to, searching for suitable registered coaches and/or registered schools, providing and managing endorsement deals, creating and uploading short query videos for registered coaches to answer, and the like.

For coaches, the platform allows the creation of a profile for free to find suitable athletes who are registered in the system. To register with the system, coaches are required to submit their name and position at school or university. Thereafter, coaches are prompted to upload a recording stating that they want to register on the platform to look for their next recruit. Based on verification of the details shared with the platform, coaches are registered on the system with limited access.

The limited access in the free package allows coaches to access minimal information about athletes' profiles. In a preferred embodiment, coaches are allowed to see a silhouette of the athletes with minimum information in the free package. Such minimum information about the athlete may include, but is not limited to, gender, race, wingspan, shoe size, hand size, height, weight, graduation class, GPA, position, geographic location, performance statistics, and the like. In an alternate embodiment, the system may display to registered coaches ratings received by the athlete and/or testimonies regarding the pros and cons of the athlete for better evaluation by the coaches.

Once a coach decides on a player selection, he/she will be prompted to complete a payment to see detailed information such as, but are not limited to, name, school, email, social media handles, parents' names and numbers, high school coach's name, contact info, and the like. This feature ensures complete confidentiality of the athlete and ensures that only genuine recruiters/coaches can contact them. In a further embodiment, coaches, upon payment, are allowed access to various performance videos uploaded by the athlete. In yet another embodiment, coaches, upon payment, are provided access to an in-depth interview of the athlete, providing insights into the athlete's personality, including their mental conditions.

In an embodiment, the system resides on a server configured to receive, segregate, and store data based on user registration type. Users may access the system through a mobile application, from which their devices may connect to the server. The server may have both storage and processing capabilities to store and process received data. In an embodiment, the system may involve a database connected to the server.

The above system is adapted to perform the method according to the present invention to facilitate athlete recruitment and endorsement by coaches/recruiters. In an embodiment, one or more processors are adapted to run one or more modules pre-stored in the server to evaluate and shortlist eligible candidates as required by a recruiter for a given event.

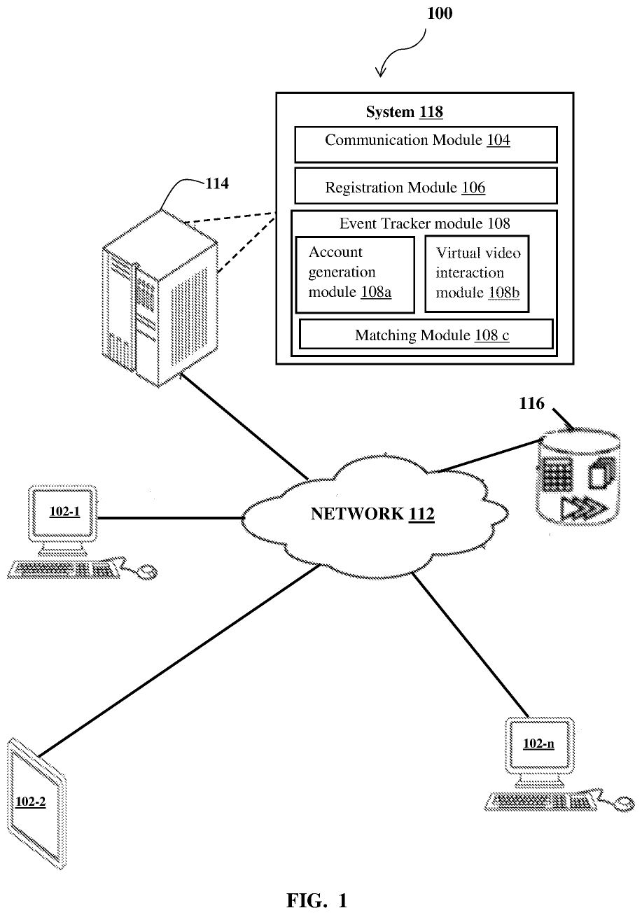

FIG. 1 illustrates a network architecture 100 for implementing a system 118 specifically aimed at sports recruitment and endorsement purposes, in accordance with an embodiment. As shown, the network is adapted to facilitate users communicating through their respective user devices 102-1, 102-2, 102-3 . . . 102-n for sports recruiting purposes over network 112. The users, collectively referred to as 102, may include individuals seeking recruitment opportunities such as a student-athlete reaching out to universities, schools, or colleges to pursue a scholarship, a spot on an athletic team, participation in an academic group or team, or similar objectives. The users may also include coaches, endorsement companies, leagues, organizational recruiters, and the like. In an embodiment, the user devices 102 may include desktop computers, tablets, smartphones, and the like adapted to communicate through other devices over mobile and internet networks.

Further, the network architecture 100 includes a server 114 configured to receive and process user information received from various users through their devices 102 and a database 116 for storing processed and unprocessed user data/information. In an embodiment, the database 116 serves as a repository for storing various predefined recruitment parameters for different types of users, current and upcoming event information, tutorials for athletes, recruiter information, and personal web pages for users, for the system to facilitate recruitment and endorsement processes.

The server 114 acts as the central hub within the network architecture 100, and is responsible for receiving and processing user information from user devices. It serves as the backbone of the system 118, handling data transmission, storage, and processing tasks to ensure seamless communication between users and system components. The database 116, which can be part of the server 114 or communicatively coupled to it, serves as a repository for storing various predefined recruitment parameters for different types of users, current and upcoming event information, tutorials for athletes, recruiter information, and personal web pages for users. This database facilitates easy searching of user profiles and enables the system to segregate and store data based on user registration type.

In an embodiment, system 118 receives input data for the registration of one or more users as athletes or recruiters from user devices. The system facilitates the connection of the user devices with the server 114 via the communication network 102 and prompts one or more users 102 to select the registration type as applicable. The selection of registration type is important for system 118 as it determines customized suggestions for the registered users. In an embodiment, system 118 receives the user selection and further prompts the user to provide data related to the chosen registration type. The data requested by the system may relate to personal and professional data.

The server 114 may have processing capabilities and may include one or more processors and memory specifically configured to execute a method in accordance with the present invention. The processors, in an embodiment, may be configured to access one or more modules and execute them in a given order, as shall be defined later.

In an embodiment, the database 116 is designed to segregate and store data based on user registration type. The database 116 can be part of the server 114 or communicatively coupled to the server 114, as shown in FIG. 1. In an embodiment, the database 116 is a relational database that facilitates easy searching of user profiles.

In an embodiment, the system 118 encompasses various software components and modules designed to support sports recruitment and endorsement purposes. In an embodiment, the server 114 executes the system 118 and specifically handles tasks related to managing user data, communication, and analysis including functionalities such as a communication module for receiving and processing user data, a registration module for user onboarding, and potentially other modules for event management and evaluation.

The communication network 112 facilitates communication between different users through their user devices 102 and is further configured to transmit real-time updates and notifications to one or more user devices 102 regarding the status of event invitations and user enrolments. The communication network 112 may be wired (using physical cables) and/or wireless communication. Examples of wireless technologies may include, but are not limited to, 802.11 (Wi-Fi), Bluetooth, CDMA, LTE, GSM, and the like. Alternatively, the communication network may be a wired network and include Ethernet Networks, Fiber Optic Networks, Coaxial Cable Networks, and the like. The users, through their user devices 102, transmit data through the communication network 112 to the server 114 for subsequent processing and user registration.

In an embodiment, system 118 includes a communication module 104 configured to receive user data from each of the user devices 102 and process it for further analysis. The communication module 104 manages the reception of data from user devices 102 and ensures seamless communication between the users and the system 118. It may handle various forms of user inputs, such as registration details, queries, requests, or updates. Upon receiving user data, the communication module 104 processes it for further analysis and subsequent actions, such as user registration or matching of suitable candidates.

In an embodiment, system 118 includes a registration module 106 responsible for facilitating the registration process for users. Module 106 facilitates the creation of comprehensive profiles for the users containing personal details, academic information, and sports-related achievements of the users and also verifies them, for example, through OTP sharing and other such processes over a mobile network or through mail confirmation. In an embodiment, the system receives the input data and processes the data for the authenticity of the information to ensure that only genuine users are registered. Upon verification, such data is then segregated and stored data based on user registration type.

For example, a user selecting athlete as a choice would receive a prompt to provide personal details as well as information on athletic skills, such as but not limited to, his/her name, address, athletic interest, athletic performance data, past sporting events participation, recommendation by other coaches, academics and/or recruiters, endorsement received and the like.

If a user selects coach/recruiter as a choice, the system may prompt the user to provide personal details and coaching history information, such as, but not limited to, academic information, years of employment with such institution, number of athletes training, sports interests, endorsement information, sports-related achievements, and the like.

Likewise, for a recruiter getting registered to the system, the information for registration may be required. In an embodiment, professional clubs, colleges, and universities may provide a link to their websites for the system to fetch details of the recruiter from the website for registration purposes.

Once the user data is analyzed and verified by system 118, registration module 106 proceeds to register the users under their specified type (athletes, coaches, recruiters) and sends the registered user information to database 116. Additionally, the registration module 106 grants access to the registered and verified users to various resources and functionalities within the system 118, such as tutorials, online resources, registered recruiter information, and the ability to create personal web pages for self-promotion aimed at enhancing their recruiting process.

In an embodiment, the registration module 106 is adapted to provide tutorials and information covering various aspects related to the recruiting process to the users including video profile creation, finding colleges and coaches, drafting effective communication, and obtaining academic clearance. The online resources may include various types of information, allowing users to leverage these materials to navigate the recruiting landscape more effectively. Examples of tutorials or recruiting-related information provided by the website or resource may include: (a) How to create an effective video; (b) Strategies for finding suitable colleges and coaches; (c) Techniques for obtaining contact information for colleges and coaches; (d) Guidance on drafting a letter or email to a college coach to introduce oneself and express interest in the program; (e) Tips on effective communication with college coaches or other recruiters; (f) Guidelines or rules for the recruiting process; (g) Direct contact information for various coaches or recruiters; (h) Information on how to package and mail a video to a recruiter; (i) Guidance on how to negotiate monetary arrangements governing participation of the athlete on University and Professional Organization Teams; (j) Guidance on how to set up and organize a company such as a Limited Liability Company and Corporate Organization that would handle negotiations with Universities and Professional Organizations on behalf of the athlete; (k) Representation of the Athlete in negotiations involving participation on College and Professional Teams in return for monetary consideration or an equity position in the Athlete's company; (l) Other relevant information; and (m) Any combination of the foregoing.

In an embodiment, system 118 includes an event tracker module 108 adapted to generate and dispatch invitations for an event to one or more registered users. The invitations are transmitted through the communication network 112 based on the matching of event criteria with stored user or athlete details. This enhances the system's capability to organize events and efficiently reach out to the relevant registered users, thereby fostering effective athlete recruitment and engagement with coaches/recruiters.

The event tracker module 108 is also configured to monitor and manage user responses to event invitations. Upon receipt of a response to the event invitation, in an embodiment, the event tracker module forwards user profile details to an account generation module for further processing.

In an embodiment, for the selection and endorsement of a registered athlete, the system executes the event tracker module 108 to generate and dispatch event invitations for various sporting events posted by registered users, such as coaches and/or endorsers, to registered users other than the event organizers. Event invitations are sent based on the event criteria set by the event organizers. The event tracker module 108 is configured to track and receive responses to the event invitations. The event tracker module 108 identifies and segregates the users 102 showing an interest in participating in the event and forwards the profile details of the registered users to its account generation module 108a.

In an embodiment, the account generation module 108a is configured to receive the user profile details received for the enrollment and enroll the users based on said details. The account generation module 108a, on receipt of such profile data of one or more registered users, creates a group having interested registered users for the specified event only. The account creation streamlines the processing of managing all the athletes effortlessly.

In particular, the account generation module 108a is configured to create a dedicated account for each enrolled user for a given event, which can be accessed by the rest of the registered users, both as part of the event or outside of the event. In an embodiment, all the users responding to the event invitation receive all the updates from the system regarding the event. This group formation facilitates streamlined communication and coordination for the event. A dedicated group having only the interested registered users, for example, athletes, as the enrolled users, facilitates the recruiters/coaches to evaluate only those athletes that match the minimum criteria preset by the event managers, who are also registered users. This criteria-based matching of a specific group of interested users not only simplifies the process of selection but also removes the trouble of interacting with those users who do not have sufficient professional qualifications to take part in the event.

In an embodiment, the event tracker module 108 includes a virtual video interaction module 108b is configured to generate and send a link to all the enrolled users, enabling them to connect with event recruiters for virtual video interaction. This interaction serves as the final evaluation of the enrolled users through the online system. The coaches provide a further scoring to all the evaluated athletes which helps rating the athletes as most suitable to least suitable for the event.

In another embodiment, the virtual video interaction module 108b encompasses various components to provide a comprehensive evaluation for the enrolled users. They include combined video footage showcasing dribbling, shooting, and athletic ability drills. Additionally, participants undergo in-depth interviews, allowing coaches to assess their personality traits and mental readiness. Furthermore, each participant's profile features a highlight video along with their most recent full game film, offering a comprehensive overview of their skills and performance. This integrated functionality not only enhances the efficiency of the evaluation process but also ensures a user-friendly and collaborative experience for both the event organizers and the enrolled users.

To further streamline the recruitment process, a matching module 108c is utilized for shortlisting enrolled users from the group. This module is configured to match users based on the stored data and final evaluation scores provided by the recruiters, ensuring a comprehensive and efficient athlete recruitment and endorsement process within the system. The scores are then statistically evaluated to rank the athletes for the event, thereby simplifying the process of selection and endorsement offers.

In an embodiment, the matching module 108c streamlines the selection process for enrolled users within the event group. This module 108c matches users based on stored data and final evaluation scores provided by recruiters, ensuring a comprehensive and efficient athlete recruitment and endorsement process within the system. This module 108c is configured to conduct a comprehensive shortlisting procedure based on the stored data and final evaluation input provided by recruiters after the virtual video interaction module 108b. Coaches provide evaluation scores for each evaluated athlete, which are statistically evaluated to rank the athletes for the event. This process simplifies selection and endorsement offers, ensuring that coaches can make informed decisions based on comprehensive athlete profiles and evaluations. The event organizers or the coaches, after completion of the video evaluation, are required to provide an evaluation score for each evaluated athlete of the group. Such scores usually relate to the criteria set by the event organizers. Additionally, such scores may relate to additional criteria set after the creation of the account by the account generation module. In a further embodiment, the matching module statistically evaluates and ranks the athlete in the order of highly suitable to least suitable based on the statistical evaluation score.

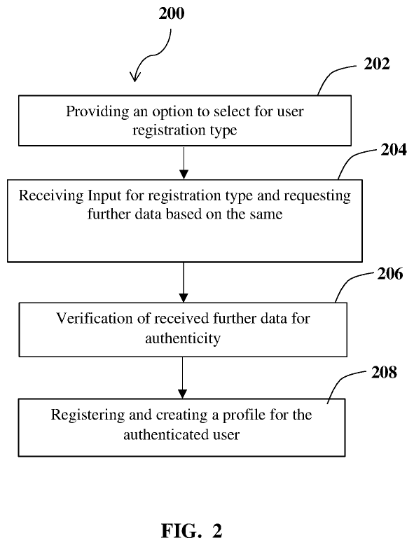

FIG. 2 illustrates a method (200) for the registration of athletes and coaches, emphasizing a seamless and personalized onboarding experience. The registration process begins with users being prompted to select their role, either as an “Athlete” or “Coach” at 202. This initial choice serves as the foundation for subsequent steps, tailoring the registration process to the specific needs and information required for each role.

Upon selecting, for example, an athlete, users are guided to input relevant information at 204, including personal details, sports disciplines, performance history, and any other pertinent data. The interface is designed to be intuitive, allowing athletes to provide comprehensive details to enhance their profile within the system. For users choosing the “Coach” role, the system guides them through a tailored set of information input fields. Coaches are prompted to provide details such as coaching experience, certifications, preferred sports disciplines, and any additional information relevant to their coaching profile.

Following the submission of athlete or coach information, the system conducts a meticulous evaluation and verification process, at 206. Athletes and coaches may be required to submit supporting documents, such as certificates, transcripts, or performance accolades, for additional validation. In addition to document verification, athletes are encouraged to upload game films or videos showcasing their skills, game strategies, and overall performance. These videos serve as a valuable supplement to the traditional document verification process, offering a real-time and practical view of the athlete's capabilities. Coaches may provide feedback or assessments based on the videos, offering an expert perspective on the athlete's strengths and areas for improvement.

Once the data is verified, users proceed to the access registration interface at 208. Athletes and coaches are prompted to create their unique login credentials, ensuring the security of their accounts. Upon successful registration, users receive a confirmation message, signaling the activation of their profiles within the system. Athletes gain access to features like performance tracking and event registration, while coaches unlock tools for athlete management and communication.

Further, the athletes are provided the option to purchase services from the platform. Such services include but are not limited to, searching for suitable registered coaches and/or registered schools, providing and managing endorsement deals, creating and uploading short query videos for registered coaches to answer, and short videos providing pieces of advice in various subjects for their recruiting process and college life and the like. Further, coaches are provided access to view questions and/or queries posed by the athlete for coaches who show interest in recruiting them.

In an alternate embodiment, registered coaches and athletes are allowed to pay an annual fee to get complete information submitted to the system at any time throughout the year, thereby reducing the obstacle of payment on a case-by-case basis. Further, the coaches are also sent notifications regarding newly registered athletes on the system or suggestions of suitable athletes based on the criteria set by coaches.

Once registered on the system, coaches are prompted to fill out a pre-defined form for re-evaluation of their registration. Such re-evaluation may be, but is not limited to, employment status, physical condition, endorsement deals, and the like.

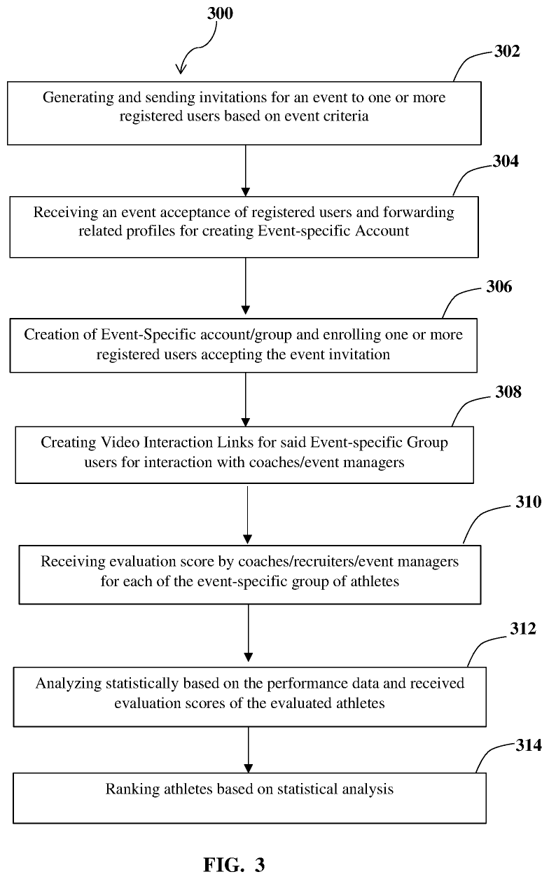

In an embodiment, FIG. 3 illustrates method 300 for an event invitation and enrolment of registered users. The process begins with the initiation of event invitations at step 302. This involves identifying relevant sports events, tournaments or showcases. Users responsible for recruitment send invitations to potential participants, encouraging them to showcase their skills at the upcoming event. The event tracker module 108 generates and sends invitations to one or more registered users based on predefined criteria. The criteria for sending invitations are predefined and could include factors such as interests, past event participation, or any other relevant information. Upon receiving responses to the event invitations, the event tracker module 108 is configured to enroll one or more registered users at 304. This involves the registration and submission of necessary information by the users. The enrolment process ensures that participants are officially accepted to participate in the event and forward related profiles for creating event-specific accounts/groups at 306. Additionally, there is created an event-specific account/group based on the event invitation. This account/group is created by the account generation module 108a and includes the enrolled users for said event.

Once the users are enrolled, an event-specific group is dynamically created at 306. The group serves as a centralized system where participants can engage with each other and share relevant information.

At step 308, the virtual video interaction module 108a generates a link within this event-specific group. This personalized link directs users to a dedicated online system, forum, or chat where participants can communicate, share updates, and engage in discussions related to the event.

The system 118, through the virtual video interaction module 108a and other evaluation tools known in the field, helps recruiters assess participants during the event at 310. The virtual video interactions encompass various components to provide a comprehensive evaluation of the enrolled users. Players/athletes within the group undergo in-depth interviews, allowing coaches to assess their personality traits and mental readiness. Furthermore, each participant's profile features a highlight video along with their most recent full game film, offering a comprehensive overview of their skills and performance. Each participant's performance is scored and recorded, forming the basis for the evaluation process. Additionally, statistical analysis is conducted based on the performance data and received evaluation scores of the evaluated athletes. Coaches provide evaluation scores for each evaluated athlete, which are statistically evaluated to rank the athletes for the event.

Based on the data collected, including statistical analysis and the evaluation scores, recruiters proceed to shortlist candidates at step 312. In an embodiment, this involves identifying standout participants who meet specific criteria and demonstrate exceptional skills or potential. Statistical analysis plays a crucial role in identifying top performers and assessing their suitability for further opportunities. This process simplifies selection and endorsement offers, ensuring that coaches can make informed decisions based on comprehensive athlete profiles and evaluations.

The shortlisted candidates are then matched with relevant leagues, colleges, or endorsers, at 314. This facilitates potential opportunities for participants based on their performance, creating pathways for further development or collaboration. The ranking of athletes based on statistical analysis further assists recruiters in identifying top talents and making informed decisions regarding potential opportunities for collaboration or advancement.

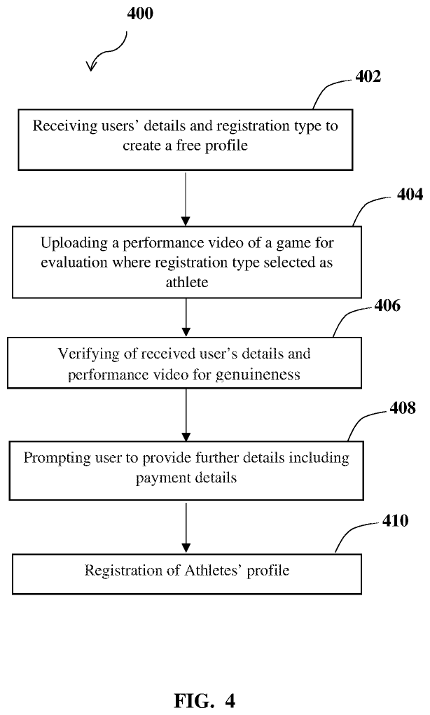

FIG. 4 illustrates method 400 for the registration of an athlete on the platform in accordance with an embodiment of the present invention. The process at step 402, receives users' information and their chosen registration type to create a free profile on the platform. In this step, users provide their details such as, but not limited to name, age, country, preferred sports, and the like, and specify the type of registration as an athlete. At Step 204, athletes are prompted to upload a performance video of their gameplay for evaluation. Said video serves as a demonstration of their skills and abilities in the respective sport or game. Further, said video is used for verifying the authenticity of the received user details for genuineness at step 406. This verification process aims to ensure that the user's identity is legitimate and matches the information provided during registration.

Upon confirmation of the received details, at Step 408, users are prompted to provide additional details. This could include more specific information such as, but not limited to, athletic background, preferences, contact details, school/college information, and the like. Additionally, if there are any associated fees or subscriptions for using the platform's services, users would also be asked to provide payment details at this stage. After completing the initial registration process and providing all necessary details, including payment information if applicable, the user's athlete profile is registered and stored on the platform and complete access is provided at step 410.

Further, the athletes are provided the option to purchase services from the platform. Such services include but are not limited to, searching for suitable registered coaches and/or registered schools, providing and managing endorsement deals, creating and uploading short query videos for registered coaches to answer, and short videos providing pieces of advice in various subjects for their recruiting process and college life and the like. Further, coaches are provided access to view questions and/or queries posed by the athlete for coaches who show interest in recruiting them.

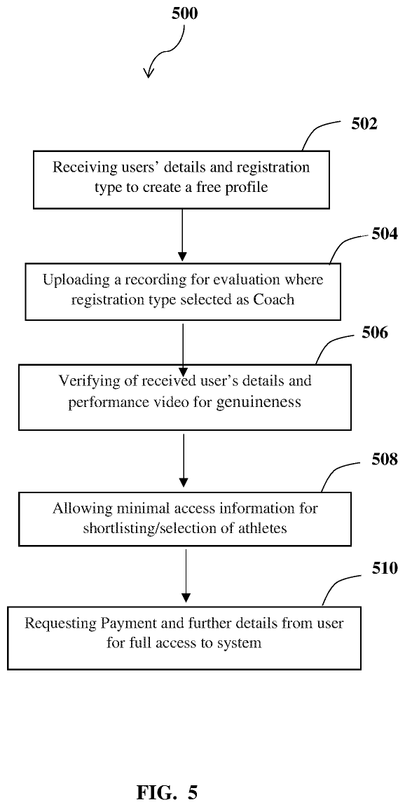

FIG. 5 illustrates method 500 for the registration of a coach on the platform in accordance with another embodiment of the present invention. At step 502, said the process involves representing users' information such as, but not limited to, name, position at a school or university, and the like, and their chosen registration type to create a free profile on the platform. Based on the received information and type selected, coaches are prompted to upload an audio recording stating “they want to register to search for the next recruit,” which is sent along with received details for further evaluation at step 504. The platform verifies the authenticity of the user's details and the uploaded audio for genuineness at step 506. Based on the verification, coaches are registered on the system with limited access to athlete information.

Coaches are allowed to see a silhouette of the athletes with minimum information in the free package. Such minimum information about the athlete may include but is not limited to, gender, race, wingspan, shoe size, hand size, height, weight, graduation class, GPA, position, geographic location, performance statistics, and the like. Coaches shortlist athletes based on their profiles, performance, or other criteria.

Once a coach decides on an athlete selection at step 508, he/she is prompted to complete a payment to see detailed or in-depth information such as, but not limited to, name, school, email, social media handles, parents' names, and numbers, high school coach's name, contact info, and the like at Step 510. This feature ensures complete confidentiality of the athlete and ensures that only genuine recruiters/coaches can contact them.

Upon completing the payment, a coach is granted access to various performance videos uploaded by the athlete. These videos serve as demonstrations of the athlete's skills and abilities, providing valuable insights for the coach's evaluation process. Such videos may include, but are not limited to, dribbling, shooting, athletic ability drills, or a combination thereof.

In another embodiment, coaches who have completed the payment process are provided access to an in-depth interview of the athlete. This interview offers insights into the athlete's personality, mindset, and mental condition, providing additional context beyond their physical performance. Understanding the athlete's character and mental attributes can be crucial for coaches in assessing their suitability for the team.

Users, typically athletes seeking recruitment or endorsement opportunities, create visual silhouette profiles. These profiles are visual representations that focus on the silhouette or outline of the athlete, showcasing key physical attributes. Coaches and endorsers utilize search and filter features within the system to identify potential sports prospects. Filters may include specific sports, positions, physical attributes, or skill sets. This enables a targeted search aligned with the requirements of the recruitment or endorsement process. Once potential prospects are identified through visual silhouettes, coaches and endorsers access detailed profiles for a deeper understanding of the athletes' backgrounds, achievements, and additional personal details.

The system offers a free search feature, enabling coaches, organizations, and endorsement companies to explore potential sports prospects through visual silhouette profiles without any upfront payment.

The system incorporates a pay-by-player model, offering flexibility to coaches, organizations, and endorsement companies to individually purchase potential sports prospects. Coaches, organizations, and endorsement companies not only have the flexibility to choose players based on their preferences but also gain confidence in the authenticity of the athletes' skills through the video verification mechanism.

Within the platform, athletes and coaches have the opportunity to engage in negotiation processes to establish mutually beneficial agreements. The negotiation mechanism serves as a pivotal aspect of the athlete-coach interaction, facilitating the discussion and agreement on various terms such as scholarship offers, training opportunities, and other pertinent factors.

The negotiation mechanism within the platform relies on the active involvement of athletes and coaches, underscoring the indispensable role of human input in shaping the outcome of agreements. Athletes, upon exploring coach profiles and identifying potential collaborators, can initiate negotiations by expressing their preferences, goals, and expectations within the platform's messaging or communication features. They may outline desired terms such as scholarship details, training regimens, or endorsement opportunities, providing a clear framework for discussion with interested coaches. Similarly, coaches can leverage the platform to engage in negotiations with prospective athletes. By reviewing athlete profiles and assessing compatibility with their programs or teams, coaches can initiate discussions regarding recruitment terms, training plans, or other relevant arrangements. They may provide offers, solicit feedback, and collaboratively refine terms based on athlete preferences and mutual objectives.

In summary, the described system offers a comprehensive solution for athlete recruitment, covering user registration, event coordination, virtual interactions, and the crucial process of shortlisting based on recruiter evaluations. The integrated modules work collaboratively to provide a seamless and efficient system for both athletes and recruiters involved in the recruitment and endorsement processes.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within understood that the phraseology or the terminology employed herein is for description and not of limitation. Therefore, while the embodiments herein have been described in terms of preferred embodiments, those skilled in the art will recognize that the embodiments herein can be practiced with modification within the spirit and scope of the appended claims.

We claim:

1. A system for facilitating recruitment and endorsement of athletes, said system comprising:
a) a server, wherein the server is adapted to receive and store user data from one or more user devices for registration of a plurality of users as athletes or recruiters to said system over a communication network that connects the one or more user devices to the system and registers the plurality of users as either athletes or coaches or recruiters;
b) a database in communication with the server and configured to store segregated user data based on a user registration type, one or more event details, and one or more sets of predefined evaluation parameters;
c) an event tracker module configured to:
(i) generate and send invitations for an event initiated by at least one registered user to one or more registered user devices via the communication network based on a matching of upcoming event criteria pre-stored in the database and the user data;
(ii) generate and send invitations for an event initiated by at least one registered user to one or more registered user devices via the communication network based on a matching of upcoming event criteria pre-stored in the database and the user data; and
(iii) receive responses from the one or more registered users and enroll the one or more registered users in the event;
d) an account generation module configured to create at least one group of enrolled users for the event, wherein each account includes structured information deduced from the information received for registrations under a plurality of categories;
e) a virtual video interaction module configured to generate and send a link to the enrolled users of said group to connect with said at least one registered user initiating the event for virtual video interaction and evaluation of the enrolled users online; and
f) a matching configured to shortlist candidates from the one or more enrolled users of said group by matching at least a set of one or more evaluation parameters for eligible candidates stored in the database with the structured information of an enrolled user for final evaluation.

2. The system according to claim 1, wherein the registration of said at least one user as an athlete on said system is based on verification of a performance video uploaded by said user and received data.

3. The system according to claim 1, wherein the registration of said at least one user as a coach on said system is based on verification of a recorded audio message identifying their intention to recruit and other data as received.

4. The system according to claim 3, wherein the registration allows limited information about athletes.

5. The system according to claim 1, wherein the system is configured to transmit real-time updates and notifications to the one or more enrolled users regarding the status of event invitations and user enrolments.

6. The system according to claim 1, wherein the account generation module selects one or more of user preferences, historical participation, and performance data as part of the structured data.

7. The system according to claim 1, wherein the virtual video interaction module facilitates video sessions, classes, seminars, in-depth interviews, and workshops for the enrolled users.

8. The system according to claim 1, wherein the system comprises a communication module facilitating the reception and transmission of data to and from the system.

9. A method for facilitating recruitment and endorsement of athletes, the method comprising:
a) receiving and storing user data from one or more user devices for registration of a plurality of users as athletes or recruiters to said system over a communication network that connects the one or more user devices to the system and registers the plurality of users as either athletes or recruiters;
b) storing segregated user data based on a user registration type, one or more event details, and one or more sets of predefined evaluation parameters in a database in communication with a server;
c) generating and sending invitations for an event initiated by at least one registered user to one or more registered user devices via the communication network based on a matching of upcoming event criteria pre-stored in the database and the user data, and receiving responses from the one or more registered users and enrolling the one or more registered users in the event by an event tracker module;
d) creating at least one group of enrolled users for the event using an account generation module, wherein each account includes structured information deduced from the information received for registrations under a plurality of categories;
e) generating and sending a link to the enrolled users of said group to connect with said at least one registered user initiating the event for virtual video interaction and evaluation of the enrolled users online using a virtual video interaction module;
f) shortlisting candidates from the one or more enrolled users of said group by matching at least a set of one or more evaluation parameters for eligible candidates stored in the database with the structured information of an enrolled user for final evaluation by a matching module.

10. The method according to claim 9, wherein the generating and sending a link comprises online invitations to workshop classes on enhancing and managing skills such as organizing an event and improving the physical abilities and mental condition of the registered users.

11. The method according to claim 10, wherein said links to workshops classes comprise guidance on negotiations with colleges, universities, and professional organizations, involving how to negotiate monetary arrangements governing the participation of the athlete on college, university, and professional organization teams.

12. The method according to claim 10, wherein said workshops comprise guidance on representation of the athlete in negotiations involving participation on college, university and professional teams in return for monetary consideration or an equity position in the athlete's company.
